(19) United States
(12) Patent Application Publication
(10) Pub. No.: US 2011/0159337 A1
(43) Pub. Date: Jun. 30, 2011

(54) BATTERY COVER ASSEMBLY FOR PORTABLE ELECTRONIC DEVICE

(75) Inventor: SHI-XU LIANG, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/780,047

(22) Filed: May 14, 2010

(30) Foreign Application Priority Data
Dec. 31, 2009 (CN) 200910312963.4

(51) Int. Cl. H01M 2/10

(52) U.S. Cl. 429/100

(57) ABSTRACT

A portable electronic device includes a housing, a battery cover, a positioning element, and a latching element. The housing defines a battery compartment. The battery cover is attached to the housing and covers the battery compartment. The positioning element attaches to the housing. The latching element attaches to the battery cover and latches with the positioning element. The latching element includes a latching portion. The positioning element and the housing cooperatively form a receiving space in which the latching portion is received.

### BACKGROUND

1. Technical Field

The exemplary disclosure generally relates to battery cover assemblies and, particularly, to a battery cover assembly and a portable electronic device utilizing the assembly.

2. Description of Related Art

Batteries are widely used in portable electronic devices, such as personal digital assistants (PDAs), mobile phones, and so on. Often, batteries are attachably received in the electronic device, and battery covers provided to connect with housings of the electronic devices to secure the batteries. Batteries are replaced by opening the battery covers when, for example, the batteries are damaged and/or dead (i.e. no longer rechargeable).

Although battery cover assemblies may be simple, the engagement between the battery cover and the housing of the mobile phone can be too strong to allow easy detachment thereof.

Therefore, there is room for improvement within the art.

### BRIEF DESCRIPTION OF THE DRAWINGS

Many aspects of the exemplary battery cover assembly can be better understood with reference to the following drawings. The components in the drawings are not necessarily drawn to scale, the emphasis instead being placed upon clearly illustrating the principles of the battery cover assembly. Moreover, in the drawings, like reference numerals designate corresponding parts throughout the several views, in which:

FIG. 1 is an exploded, isometric view of an exemplary embodiment of a portable electronic device;

FIG. 2 is similar to FIG.1, but viewed from another aspect;

FIG. 3 is an isometric view of a housing of the portable electronic device of FIG. 1;

FIG. 4 is similar to FIG. 3, but viewed from another aspect;

FIG. 5 is an enlarged view of a base of the portable electronic device of FIG. 1;

FIG. 6 is similar to FIG. 6, but viewed from another aspect;

FIG. 7 is an isometric view of a positioning element of the portable electronic device of FIG. 1;

FIG. 8 is similar to FIG. 7, but viewed from another aspect;

FIG. 8 is an isometric view of a latching element of the portable electronic device of FIG. 1;

FIG. 10 is an enlarged view showing a battery cover assembly separated from the housing;

FIG. 11 is an enlarged view showing the latching element attached to the positioning element; and

FIG. 12 is an isometric view of the portable electronic device in a closed state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

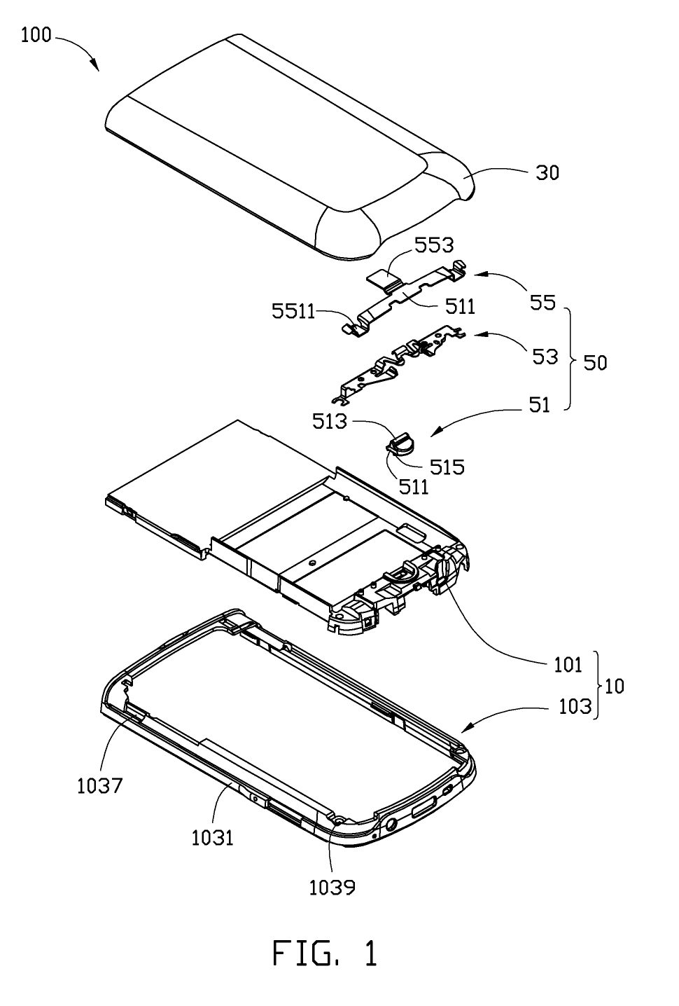

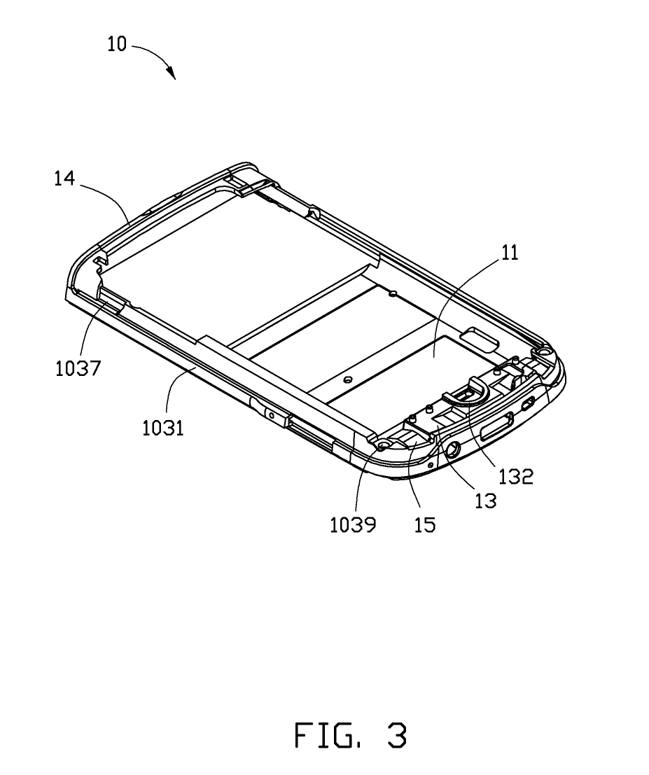

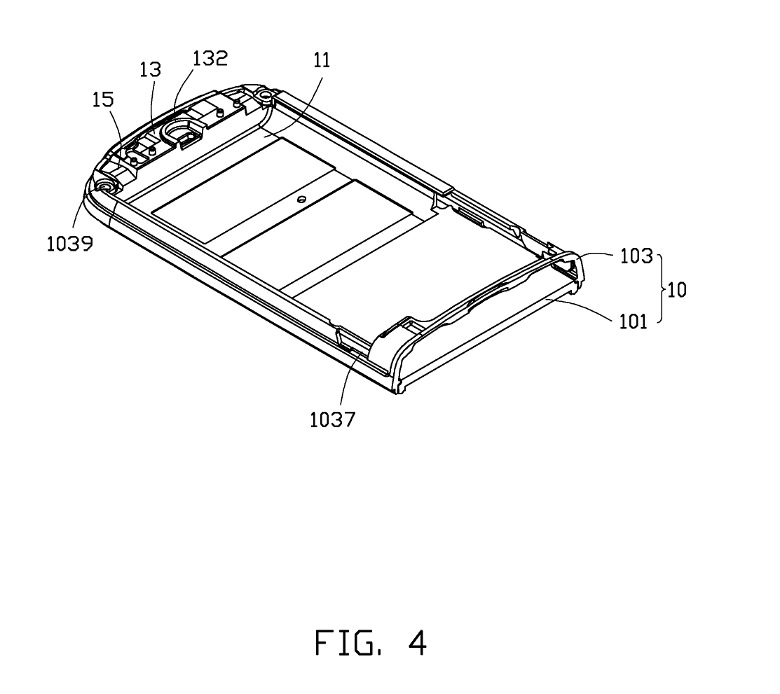

FIG. 1 shows an exemplary embodiment of a portable electronic device 100, such as cellular phone or any electronic device including a battery. The portable electronic device 100 includes a housing 10, a battery cover 30, and a latching module 50. The battery cover 30 is removably attached to the housing 10 by the latching module 50. The housing 10 includes a base 101 and a frame 103 attached to the base 101, as shown in FIGS. 3 and 4. The latching module 50 includes an elastic element 51 received in the base 101, a positioning element 53 attached to the base 101, and a latching element 55 attached to the battery cover 30.

Referring back to FIG. 1, the frame 103 includes a stepped sidewall 1031 engaging with the base 101. One end of the frame 103 defines a latching slot 1037 in each of two sides, and the other end of the frame 103 defines a through hole 1039 in each of two corners.

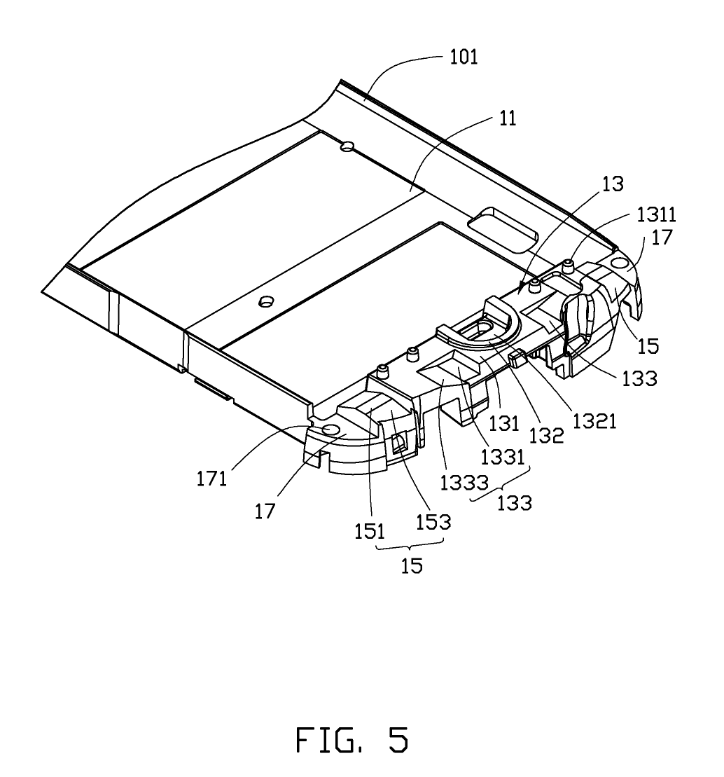

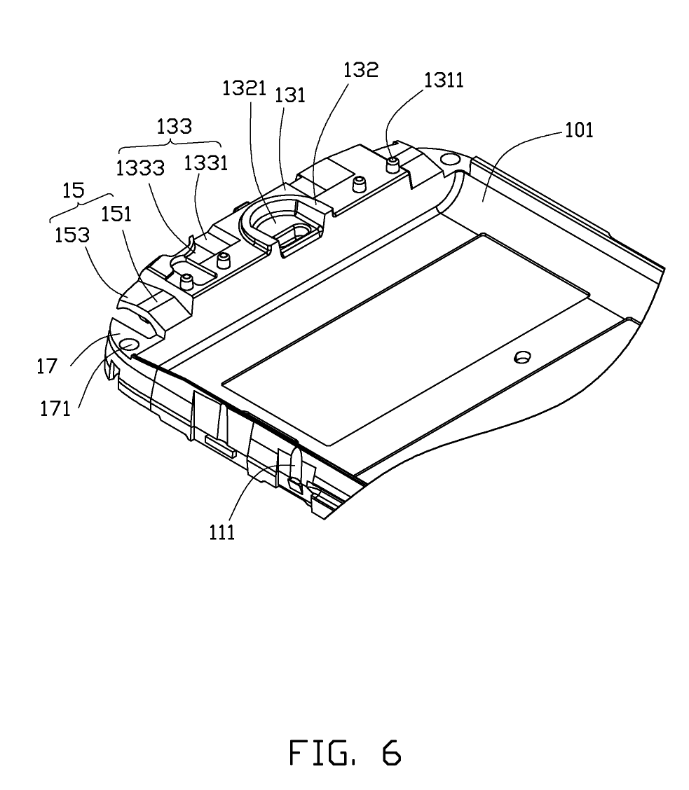

Referring to FIGS. 5 and 6, the base 101 defines a battery compartment 11 for receiving a battery (not shown) to provide power for the portable electronic device 100. The base 101 includes an end portion 13 adjacent to the battery compartment 11 and an opposite end section 14 (shown in FIG. 3). The end portion 13 includes a supporting surface 131. A block 132 and four posts 1311 project upwards from the supporting surface 131. The block 132 defines a stepped groove 1321 for receiving the elastic element 51. Two cutouts 133, surrounded by a positioning surface 1331 and a beveled surface 1333, are defined in the supporting surface 131 and symmetrically disposed at two sides of the block 132. The end portion 13 has a first stepped portion 15 and a second stepped portion 17 at each of two sides. Each of the first stepped portions 15 includes a resisting surface 151 and a beveled guiding surface 153 connecting to the resisting surface 151. The second stepped portions 17 each define a receiving hole 171 to align with a corresponding through hole 1039.

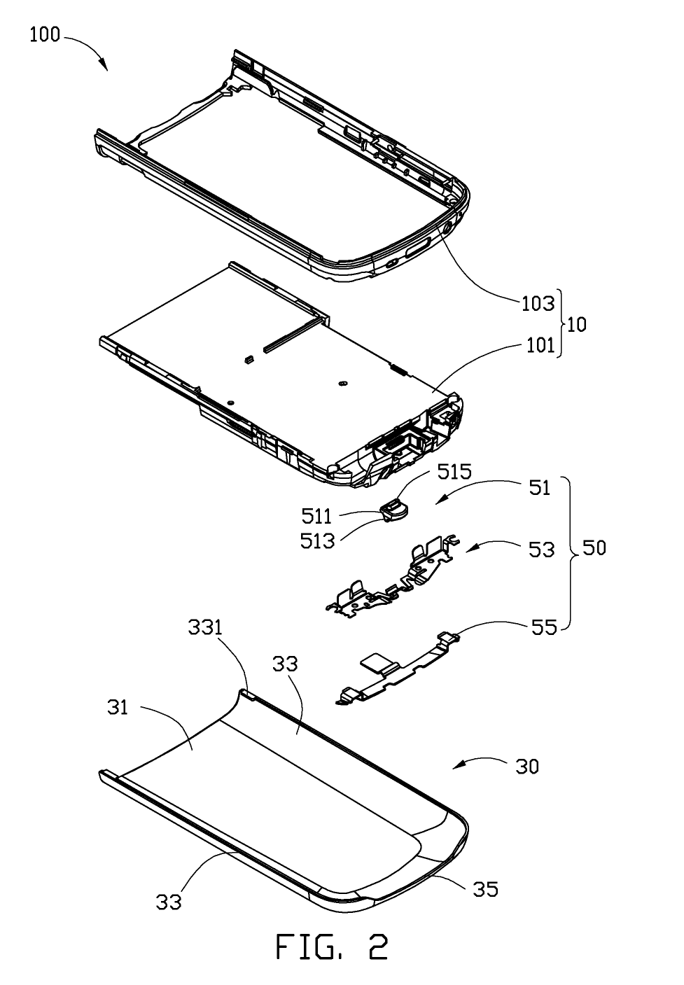

Referring back to FIG. 2, the battery cover 30 is a substantially rectangular shell with a top cover surface 31, two cover sidewalls 33, and a cover end wall 35 connecting to the two cover sidewalls 33. A tab 331 extends from one end of each cover sidewall 33. The two tabs 331 are arranged parallel to each other and each tab 331 is dimensioned and arranged to mate in a corresponding latching slot 1037 of the frame 103.

The elastic element 51 includes a main portion 511, a first elastic projection 513 directly extending from one end of the main portion 511, and a second projection 515 directly extending from the other end of the main portion 511. The second projection 515 and the main portion 511 are respectively received in the stepped grooves 1321.

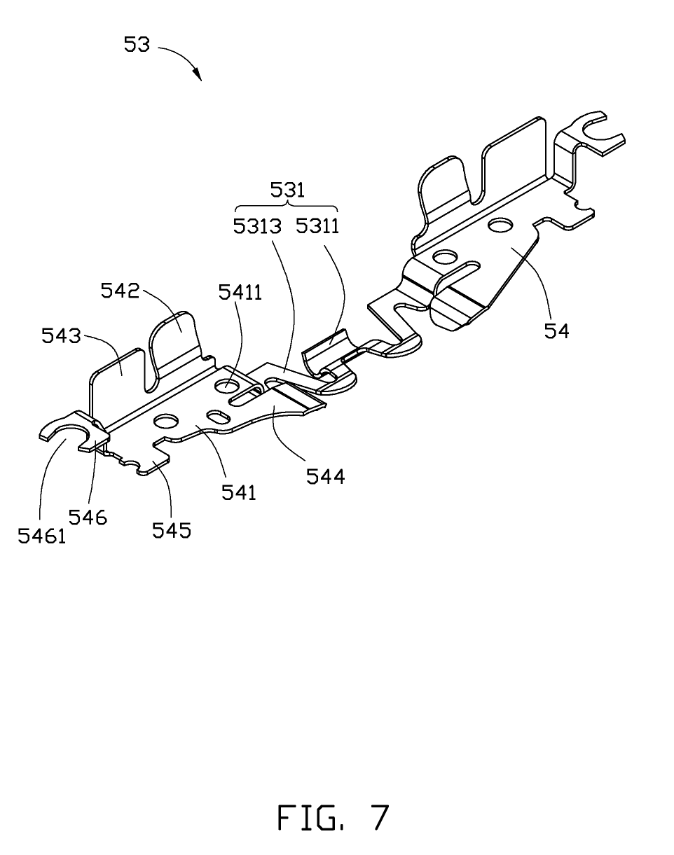

Referring to FIG. 7, the positioning element 53, for retaining the latching element 55 to the housing 10, includes a connecting portion 531 and two positioning portions 54 symmetrically formed beneath the two sides of the connecting portion 531. A space between the connecting portion 531 and each of the positioning portions 54 is approximately the same size as the block 132. The connecting portions 531 are approximately W-shaped and include an arcuate projection 5311 acting as the central portion of the W-shape and two arm portions 5313 acting as two arms of the W-shape.

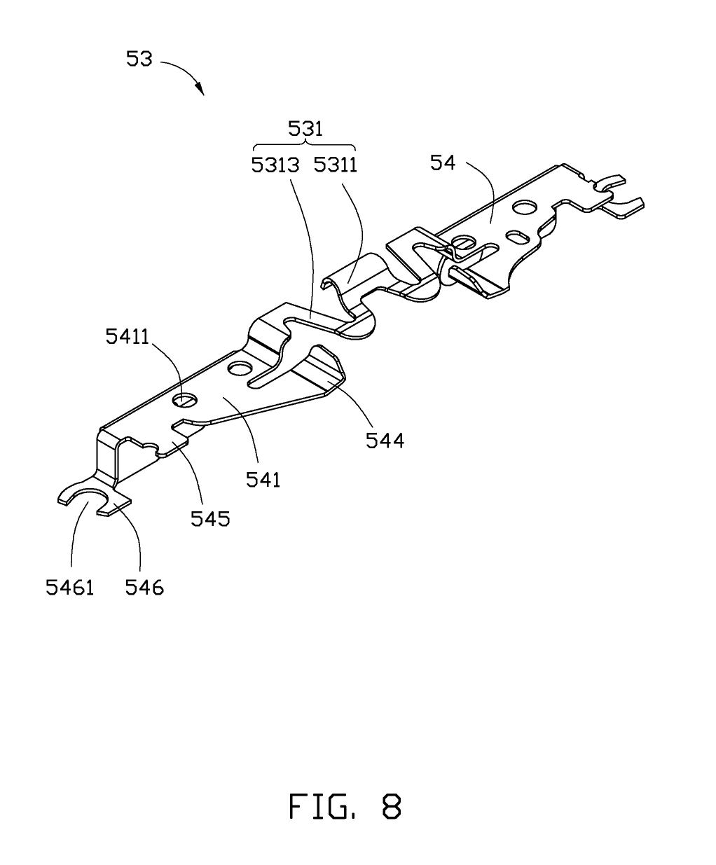

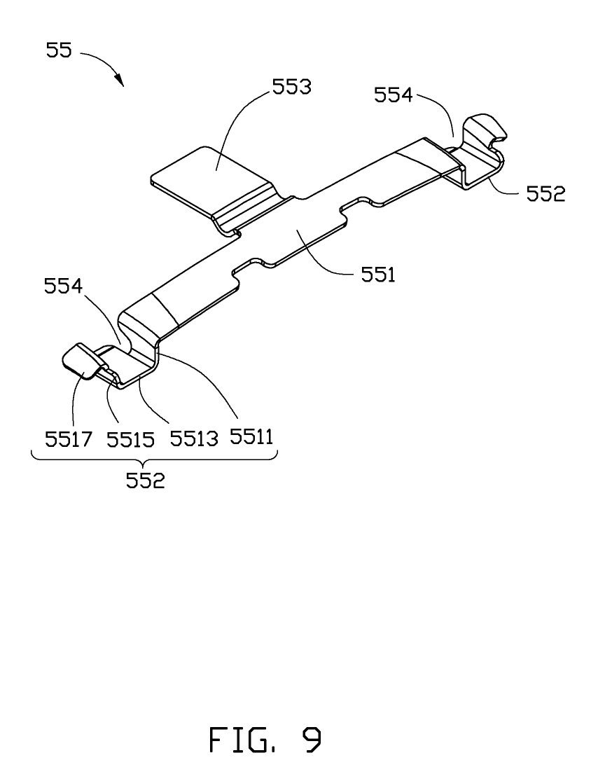

Each of the positioning portions 54 includes a plate 541, an elastic resisting sheet 542 projecting upwards from the plate 541 at an angle, a positioning tab 543 projected upwards from the plate 541 at the same side as the resisting tab 542, a flange 544 extending from the edge opposite the resisting tab 542 with the free end curving downwards, a latching tab 545 extending away from the plate 541 and away from the positioning tab 543, and a retaining portion 546 with a stepped notch 5461 formed at the end opposite to the connecting portion 531. The plate 541 of each positioning portion 54 is substantially rectangular and defines two positioning holes 5411 for receiving the corresponding posts 1311, as shown in FIG. 8.

Referring to FIG. 9, the latching element 55 includes a base portion 551 and a securing portion 553 perpendicularly connecting to approximately the middle of the base portion 551. A generally U-shaped latching portion 552 is formed at each end of the base portion 551. Each of the latching portions 552 has a first latching wall 5511 extending downwards from the base portion 551 as one arm of the U-shape, a latching sheet 5513 approximately parallel to the base portion 551 forms the middle portion of the U-shape, a second latching sheet 5515 approximately parallel to the first latching wall 5511 forms the other arm of the U-shape, and each latching portion 552 further includes a distal end 5517 coplanar with the base portion 551. The first latching sheet 5511, the latching sheet 5513, and the second latching sheet 5515 cooperatively define a channel 554 for receiving a corresponding latching tab 545.

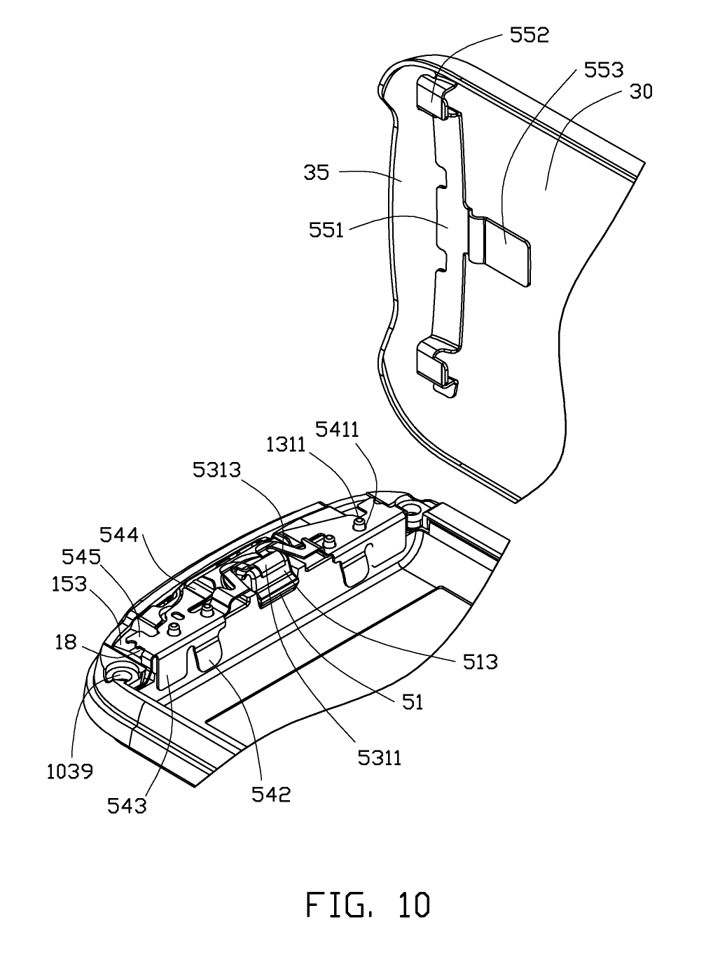

During assembly of the portable electronic device 100, the second projection 515 and the main portion 511 of the elastic element 51 are received in the stepped groove 1321, and the first projection 513 of the elastic element 51 extends upwards from the supporting surface 131 of the base 101. The posts 1311 of the base 101 are aligned with and received in the positioning holes 5411 such that the positioning element 53 is positioned on the base 101. In the exemplary embodiment, the positioning element 53 is fixed to the base 101 via heat-melting. After the attachment, the first projection 511 elastically resists the arcuate projection 5311. The flanges 544 each are received in a corresponding cutout 133. The latching tab 545 is placed upwards of the resisting surface 151 and together with the surface 151 cooperatively forms a receiving space 18 (shown in FIG. 10) for receiving a corresponding latching sheet 5513. The retaining portions 546 each resist a corresponding second stepped portion 17 with each notch 5461 aligning with a corresponding receiving hole 171. Each of the positioning tabs 543 resists the sidewall of the end wall adjacent to the battery compartment 11. Each of the resisting tabs 542 extends into the battery compartment 11 to press against the battery received in the battery compartment 11. The interior surface of the sidewall 1031 of the frame 103 engages with the sidewall of the base 101 such that the frame 103 is attached to the base 101 and cooperatively forms the housing 10. The through holes 1039 respectively align with the notches 5461 and the receiving holes 171.

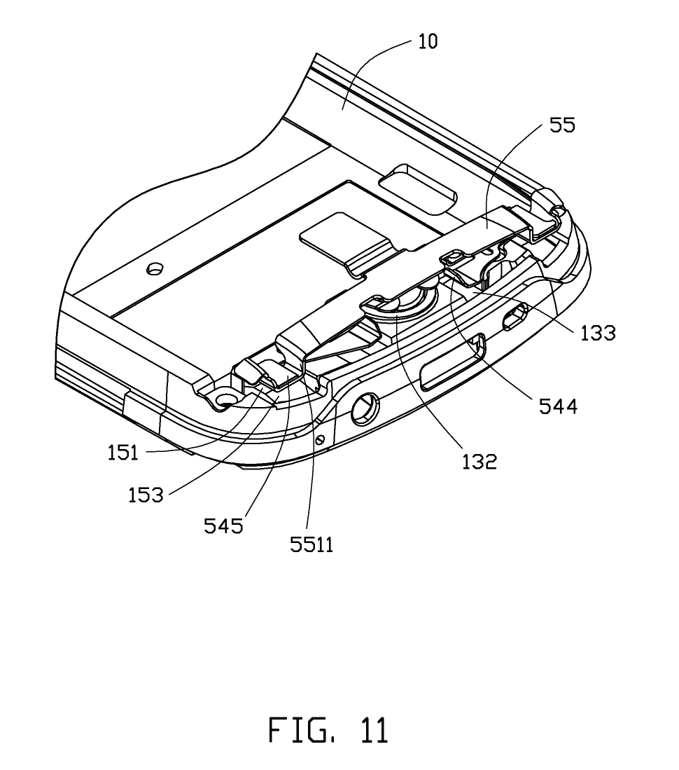

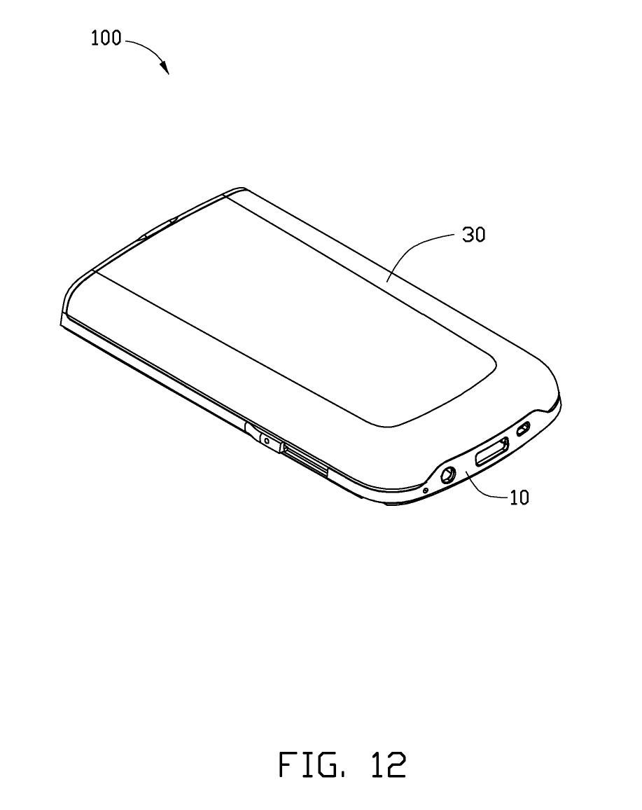

The securing portion 553 of the latching element 55 is attached to the battery cover 30, as shown in FIG. 10 by laser melting in this embodiment. The battery cover 30 with the latching element 55 is attached to the housing 10. The latching protrusions 331 of the battery cover 30 are respectively received in the latching slots 1037. The latching sheets 5513 are respectively received in the corresponding receiving space 18 as shown in FIG. 11. Thus, the portable electronic device 100 is assembled, as shown in FIG. 12.

The base 101, the frame 103, and the positioning element 53 can be integratively formed, e.g., via co-molding. Further, the positioning element 53 can be fixed to the base 10 via melting such that the retaining portions 546 can be omitted.

In the present disclosure of the portable electronic device 100, because the surfaces 5513 are received in the receiving spaces 18 formed between the resisting surfaces 151 and the latching tabs 545, and the latching tabs 545 are received in a corresponding channel 554 defined by the first latching walls 5511, the latching sheets 5513, and the second latching walls 5515, avoid too strong of an engagement between the battery cover 30 and device 100.

When a battery is to be replaced or installed, the battery cover 30 is slid to move away from the end section 14 of the housing 10, the latching protrusions 331 respectively separate from the latching slots 1037 and the latching tabs 545 respectively separate from the latching portions 552, accordingly, the battery cover 30 can be removed from the housing 10.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device comprising:
a base defining a battery compartment;
a battery cover for covering the battery compartment;
a latching module comprising:
a positioning element attached to the base;
a latching element attached to the battery cover and for latching with the positioning element;
wherein the latching element includes a latching portion, the positioning element and the base form a receiving space, in which the latching portion is received.

2. The portable electronic device as claimed in claim 1, wherein the latching portion defines a channel, the positioning element forms a latching tab received in the channel and resists the latching portion.

3. The portable electronic device as claimed in claim 2, wherein the positioning element includes a latching tab, the base includes a first stepped portioning portion comprising a resisting surface, the resisting surface and the latching tab form the receiving space, the channel of the latching portion is cooperatively defined by a first latching wall, a latching sheet, and a second latching wall approximately parallel to the first latching wall, the latching sheet is received in the receiving space and resists the latching tab, and the latching tab is received in the channel.

4. The portable electronic device as claimed in claim 1, further comprising an elastic element resisting the positioning element, the base forming a block with a groove, in which the elastic element being received.

5. The portable electronic device as claimed in claim 4, wherein the elastic element comprises a main body, a first elastic projection extending from one end of the main portion and resisting the positioning element, a second projection extending from the other end of the main portion, the second projection and the main portion are received in the groove.

6. The portable electronic device as claimed in claim 4, wherein the positioning element comprises a connecting portion resisted by the elastic element and two positioning portions formed at the two opposite ends of the connecting portion, the base has a supporting surface resisting the two positioning portions and the block projects from the supporting surface.

7. The portable electronic device as claimed in claim 6, wherein two posts projects from the base, each of the positioning portions defines a positioning hole, in which the posts are received.

8. The portable electronic device as claimed in claim 6, wherein each of the positioning portions extends a flange, the base defines two cutouts, in which the flanges are received.

9. The portable electronic device as claimed in claim 6, wherein each of the flanges includes a curved end, each of the cutouts is surrounded by a positioning surface resisting a corresponding curved end and a beveled surface connecting to the positioning surface.

10. The portable electronic device as claimed in claim 6, wherein each of the positioning portions projects a positioning tab for resisting the base.

11. The portable electronic device as claimed in claim 6, wherein each of the positioning portions projects a resisting tab extending into the battery compartment and for resisting a battery received in the battery compartment.

12. A portable electronic device comprising:
a housing defining a battery compartment;
a battery cover removably attached to the housing for covering the battery compartment;
a positioning element attached to the housing;
a latching element attached to the battery cover and for latching with the positioning element;
wherein the latching element includes a latching portion, the positioning element and the housing form a receiving space, in which the latching portion is received.

13. The portable electronic device as claimed in claim 12, wherein the latching portion defines a channel, the positioning element forms a latching tab received in the channel and resisting the latching portion.

14. The portable electronic device as claimed in claim 13, wherein the positioning element includes a latching tab, the housing includes a first stepped portioning portion comprising a resisting surface, the resisting surface together with the latching tab form the receiving space, the channel of the latching portion is cooperatively defined by a first latching wall, a latching sheet, and a second latching wall approximately parallel to the first latching wall, the latching sheet is received in the receiving space and resists the latching tab, and the latching tab is received in the channel.

15. The portable electronic device as claimed in claim 12, further comprising an elastic element resisting the positioning element, the housing forming a block with a groove, in which the elastic element being received.

16. The portable electronic device as claimed in claim 13, wherein the positioning element comprises a connecting portion resisted by the elastic element and two positioning portions formed at the two opposite ends of the connecting portion, the housing includes a supporting surface resisting the two positioning portions and the block projects from the supporting surface.
